(19) United States
(12) Patent Application Publication
(10) Pub. No.: US 2006/0159832 A1
(43) Pub. Date: Jul. 20, 2006

(54) Composite material of vegetable fiber, its products and manufacturing method thereof

(76) Inventor: Cheng Ping Lin, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/037,174

(22) Filed: Jan. 19, 2005

(51) Int. Cl. A23L 1/212

(52) U.S. Cl. 426/615

(57) ABSTRACT

The present invention is to provide a composite material of vegetable fiber, its products and manufacturing method thereof. According to the composite material of vegetable fiber of present invention, it is obtained by mixing 20%˜50% of vegetable fibers, 20%˜50% of starches, 20%˜50% of rice powders and 5%˜20% edible or in edible coloring agent. While its products are obtained by adding the water into the composition material and steering, pouring it into molds, heating it between the temperature of 130° C.˜180° C. and controlling the pressure between 10 Mpa˜20 Mpa. Then to obtain food container without any harm to people and to the earth.

### BACKGROUND OF THE INVENTION

1. Field of the Invention

The present invention relates to products made of composite material of vegetable fiber, and the method for manufacturing the products. Especially, the products can be dissolved completely in the soil.

2. Description of the Prior Art

It is known that Taiwan is one of the largest consumer markets for disposable food container. According to the estimated record of Taiwan at present time, the annual necessity for food containers at present is about 10 billion pieces, whereas, the annual necessity for water cups is about 20 billion pieces, the annual growth rate for said products is 6%.

The disposable food containers can mainly be divided into three kinds: the paper products, the spongy products and dissolvable plastic products, their properties are respectively stated as follows:

1. The spongy food container: it is produced by spongy polyethylene, its hardness is low and heat tolerance is weak. It begins to soften at 85° C. and to release poisonous material, that is, dioxin (poly-chlorinated biphenyl). Furthermore, it cannot be dissolved and corrupted for a very long time; it then will cause another kind of pollution after being used by people. The poisonous gases released after it is burnt will not only cause air pollution, ecologic and environmental destruction, but also cause harm to people's body.

2. The paper food container: it is weak in waterproofing and oil proofing. Also, it is low in hardness. The manufacturing of its rough material, i.e. pulp, has to cut down the trees and exhaust polluted water, and then it causes another kind of destruction to environment. Furthermore, the paper food container is high in cost; this is also disadvantageousness to its uses.

3. The dissolvable plastic food container: by adding dissolvable photo sensitive agent and starches into plastics to obtain dissolvable materials, then put the materials into molds to form various kinds of containers. It is good in water proofing, good in oil proofing and nonpoisonous. However, its hardness is how and the dissolution process depends on external conditions, such as proper sunshine, air, water, soil, microbes. In actual uses, it always not entirely dissolved in the ground, but only can be dissolved from large pieces to small pieces.

### SUMMARY OF THE INVENTION

The present invention is to provide a composite material of vegetable fiber, its products and manufacturing method thereof. According to the composite material of vegetable fiber of present invention, it is obtained by mixing 20%˜50% of vegetable fibers, 20%˜50% of starches, 20%˜50% of rice powders and 5%˜20% edible or in edible coloring agent. While its products are obtained by adding the water into the composition material and steering, pouring it into molds, heating it between the temperature of 130° C.˜180° C. and controlling the pressure between 10 Mpa˜20 Mpa. Then to obtain food container without any harm to people and to the earth.

According to the composite material of vegetable fiber, its products and manufacturing method of present invention, wherein the vegetable fiber is mainly the bamboo powder. The particles of the bamboo powder, the starches and the rice powder are preferably controlled to be between 20 mesh˜100 meshes. While the water for mixing and steering is preferably to make the rough material contain 5˜20% of water, this is another object of present invention.

According to the composite material of vegetable fiber, its products and manufacturing method of present invention, wherein in the process of molding, the hardness and tenacity of the container is strengthen by 4˜9 times of discontinuous gas exhausting. Such that the food containers, cups, dishes and packaging goods of water proofing, heat tolerant, corruption tolerant, nonpoisonous, nonpolluting, and entirely dissolvable in soil can be obtained. This is a further object of present invention.

### BRIEF DESCRIPTION OF THE DRAWINGS

The accompanying drawing, which is included to provide a further understanding of the invention, and incorporated in and constitute a part of this specification, illustrate embodiments of the invention and together with the description serve to explain the principles of the invention, wherein:

FIG. 1 is a flow chart showing the manufacturing process of present invention.

### DETAILED DESCRIPTION OF THE PREFERRED EMBODIMENTS

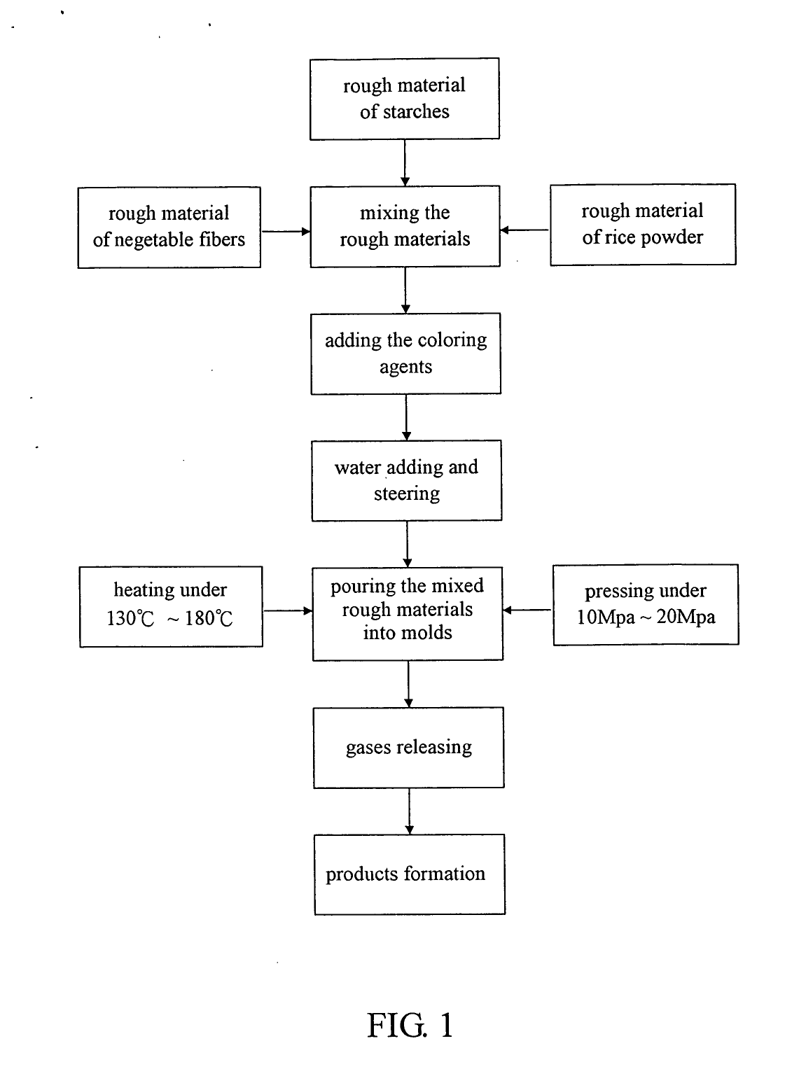

As shown in FIG. 1, the composite material of vegetable fiber and its products are manufactured according the following steps:
1. Obtaining the rough material powder of vegetable fiber: the vegetable fiber is obtained from the plant of bamboo, after the vegetable fiber of bamboo is obtained, it is grinded to powder and then mixed with starches and edible rice powder. The mixing ratio of vegetable fiber to starches and rice powder is 20˜50%: 20˜50%:20˜50%;
2. Steering: the mixture of vegetable fiber, starches and rice powder is steered by steering machine to obtain uniformly mixed powders;
3. Adding the coloring agent and steering: the coloring agent can be edible coloring agent or inedible coloring agent, and, the coloring agent is added into said steered mixed powders and then steering again to obtain mixture of powders having 5˜20% of coloring agent;
4. Adding the water: the water is added into the mixture powders having coloring agent, and, the percentage of water contained in the mixture of powders having coloring agent is 5˜20%;
5. Molding: pouring the mixture of powders having coloring agent mentioned above into molds, continuously heating said material with the temperature between 130˜180° C. and keeping the pressure inside the molds between 10 Mpa˜20 Mpa;
6. Gases releasing: in the process of molding, the gases are released for 4˜9 times, wherein, the upper and lower molds are separated for 2˜10 seconds to enable gases inside the material be released from the molds. During the process of gases releasing, heating process is continuously to be operated;
7. Curing and formation: after the process of gases releasing, the products are cured and the formation of products is completed.

The above mentioned vegetable fibers include bamboo powders, starches and rice powders, the particle dimensions of said powders are preferably between 20˜100 meshes. The bamboo powder wherein can be obtained by milling machine, while both of starches and lice powders can be obtained by water-grinder.

Regarding the coloring agents, the edible coloring agent is suitable for food container; the inedible coloring agent is suitable for non-food containers. i.e. packing containers.

By using the above steps, the environmental food containers, cups, dishes, packing goods with functions of water proofing, heat tolerant, corruption tolerant, nonpoisonous, nonpolluting and entirely dissolvable in soil can be obtained.

In conclusion, the manufacturing method of present invention has the following features:
1. The rough materials can be mainly used in the present invention are hybrid materials of vegetable fibers. And part of rough materials can be the renewable wasted materials. They are convenient to obtain, and the costs are very low.
2. The products obtained by the method of present invention can comply with the request of “environmental protection”. And all the products are entirely dissolvable in the soil.

It can be seen from the above statement that, the present invention can actually provide products entirely complying the request of environmental protection, and the products can be obtained by molding formation of continuous processes. It has not been seen in the products opened to public, it then complies with conditions of approvable patents.

Other embodiments of the present invention will become obvious to those skilled in the art in light of above disclosure. It is of course also understood that the scope of the present invention is not to be determined by the foregoing description, but only by the following claims.

1. A method for manufacturing products of composit material of negetable fibers, including the steps of:
a. Obtaining the rough material powder of vegetable fiber: the vegetable fiber is obtained from the plant of bamboo, after the vegetable fiber of bamboo is obtained, it is grinded to powder and then mixed with starches and edible rice powder. The mixing ratio of vegetable fiber to starches and rice powder is 20˜50%: 20˜50%:20˜50%.
b. Steering: the mixture of vegetable fiber, starches and rice powder is steered by steering machine to obtain uniformly mixed powders;
c. Adding the coloring agent and steering: the coloring agent can be edible coloring agent or inedible coloring agent, and, the coloring agent is added into said steered mixed powders and then steering again to obtain mixture of powders having 5˜20% of coloring agent;
d. Adding the water: the water is added into the mixture powders having coloring agent, and, the percentage of water contained in the mixture of powders having coloring agent is 5˜20%;
e. Molding: pouring the mixture of powders having coloring agent mentioned above into molds, continuously heating said material with the temperature between 130˜180° C. and keeping the pressure inside the molds between 10 Mpa˜20 Mpa;
f. Gases releasing: in the process of molding, the gases are released for 4˜9 times, wherein, the upper and lower molds are separated for 2˜10 seconds to enable gases inside the material be released from the molds. During the process of gases releasing heating process is continuously to be operated;
g. Curing and formation: after the process of gases releasing, the products are cured and the formation of products is completed.

2. The method as claimed in claim 1, wherein said vegetable fibers include bamboo fibers or other fibers obtained from other plants.

3. The method as claimed in claim 1, wherein the particle dimensions of said powders are preferably between 20˜100 meshes.

4. The method as claimed in claim 1, wherein the coloring agent is an edible coloring agent or in edible coloring agent, depending on the use of products.

5. A product of composite vegetable fiber material, it is manufactured by the method claimed in claim 1.
